(19) United States
(12) Patent Application Publication
(10) Pub. No.: US 2005/0067208 A1
(43) Pub. Date: Mar. 31, 2005

(54) Vehicle differential gear

(76) Inventor: Dar-Hsiang Cheng, Tainan City (TW)

Correspondence Address: Dar-Hsiang CHENG, P.O. Box 90, Tainan City, 704, TW

(21) Appl. No.: 10/669,458

(22) Filed: Sep. 25, 2003

(51) Int. Cl. B60K 17/344

(52) U.S. Cl. 180/248

(57) ABSTRACT

A vehicle differential gear includes a power unit, a differential gear, two wheels and a brake. The power unit has a transmission wheel extending outward. The differential gear has one outer side threadably assembled with a driven wheel connected with the transmission wheel by a belt. The two wheels respectively have a transmission shaft connected with the bevel gear unit of the differential gear and driven to rotate by the differential gear. The brake is assembled with the differential gear to control the differential gear and brake a car. Thus, a proper driven wheel can be chosen for use according to preset running speeds of a car and then it is threadably assembled on one outer side of the differential gear, needless to make molds for various components to suit different running speeds of a car.

### BACKGROUND OF THE INVENTION

1. Field of the Invention

This invention relates to a vehicle differential gear, particularly to one provided with a power unit, a differential gear, two wheels and a brake. The power unit is provided with a transmission wheel extending outward from one side, and the differential gear has one outer side assembled threadably with a driven wheel connected with the transmission wheel of the power unit by a belt. The two wheels respectively have a transmission shaft connected at the opposite sides of the differential gear to be driven to rotate by the differential gear. The brake is assembled with the differential gear to control the differential gear and brake a car. Thus, a proper driven wheel can be chosen for use according to preset running speed of a car and then it is assembled on one outer side of the differential gear, needless to make various molds for producing various components to match with different running speeds of a car and able to brake a car smoothly and effectively by operating the brake to stop the differential gear and actuate the transmission wheel to stop rotating.

2. Description of the Prior Art

A conventional electrically driven car has a differential gear assembled on its chassis and connected with a left and a right wheel so as to enable the car to make a turn smoothly and prevent overturning. Nevertheless, a conventional gear has its inner gear meshed with a speed-reducing gear unit and is directly driven by a D.C. motor to rotate at a constant speed which is unable to be increased. Further, after the motor and the speed-reducing gear and the differential gear are assembled together, they are wrapped up by a sealing shell, increasing producing cost.

In addition, a conventional brake is connected with the wheel of a car for directly controlling the wheel to reduce rotating speed or stop rotating for braking the car, but such a conventional brake can only brake a wheel (a front wheel or a rear one) connected by a braking line; therefore during braking, only a single wheel is pressed to reduce speeds and a whole braking force is imposed on this wheel, most likely to cause wear to the brake. Furthermore, when the conventional brake carries out braking, the wheel is controlled to stop rotating, but at this time the wheel shaft still outputs power to the wheel and then the wheel stops rotating rapidly and reacts back to the differential gear, resulting in a slow reaction stroke and failing to brake a car with great effect.

### SUMMARY OF THE INVENTION

One objective of the invention is to offer a vehicle differential gear having a driven wheel selectable in its specifications in accordance with preset running speeds of a car and threadably assembled on one outer side of the differential gear, needless to make various molds for producing various components to suit different running speeds of a car, convenient to be assembled and having practicability.

Another objective of the invention is to offer a vehicle differential gear having a brake assembled on one side. The control member of the brake is operated to stop the differential gear and simultaneously actuate the transmission wheel of a power unit to stop rotating, able to brake a car smoothly and effectively.

A first feature of the invention I a power unit provided with a transmission wheel extending outward from one side; a differential gear connected with the power unit and provided inside with a bevel gear unit, having one outer side threadably assembled with a driven wheel which is connected with the transmission wheel of the power unit by a belt and able to actuate the differential gear to rotate; two wheels respectively having a transmission shaft connected with the bevel gear unit of the differential gear so that the wheels can be driven to rotate by the differential gear.

A second feature of the invention is a power unit provided with transmission wheel extending outward from one side; a differential gear connected with the power unit and provided inside with a bevel gear unit, having one outer side threadably assembled with a driven wheel which is connected with the transmission wheel of the power unit by a belt to drive the differential gear to rotate; two wheels respectively having a transmission shaft connected with the bevel gear unit of the differential gear, with the transmission shaft covered with a shaft sleeve; a brake assembled with the differential gear and composed of a brake saucer, a brake clamping member and a control member, the brake saucer fixed on one side of the differential gear to rotate together with the differential gear, the brake clamping member and the control member assembled on the shaft sleeve of the wheel, with the brake clamping member aligned to and able to tightly clamp the broke saucer.

### BRIEF DESCRIPTION OF DRAWINGS

This invention will be better understood by referring to the accompanying drawings, wherein:

FIG. 1 is an exploded perspective view of a vehicle differential gear in the present invention;

FIG. 2 is a perspective view of the vehicle differential gear in the present invention;

FIG. 3 is a cross-sectional view of a first preferred embodiment of the vehicle differential gear in the present invention; and,

FIG. 4 is a cross-sectional view of a second preferred embodiment of the vehicle differential gear in the present invention.

### DETAILED DESCRIPTION OF THE PREFERRED EMBODIMENT

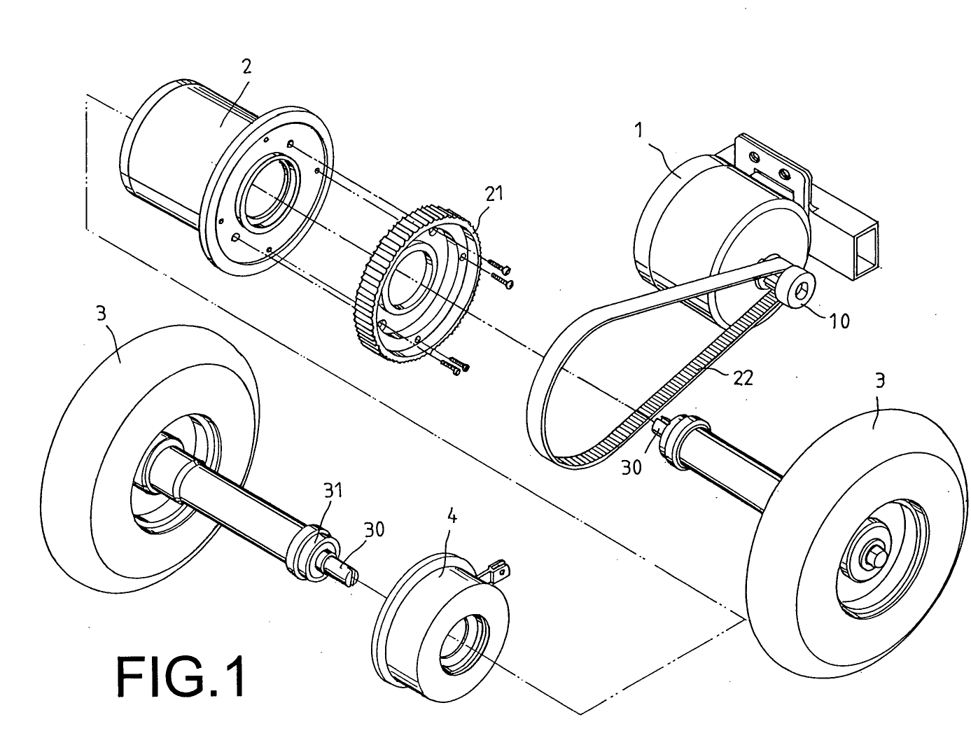

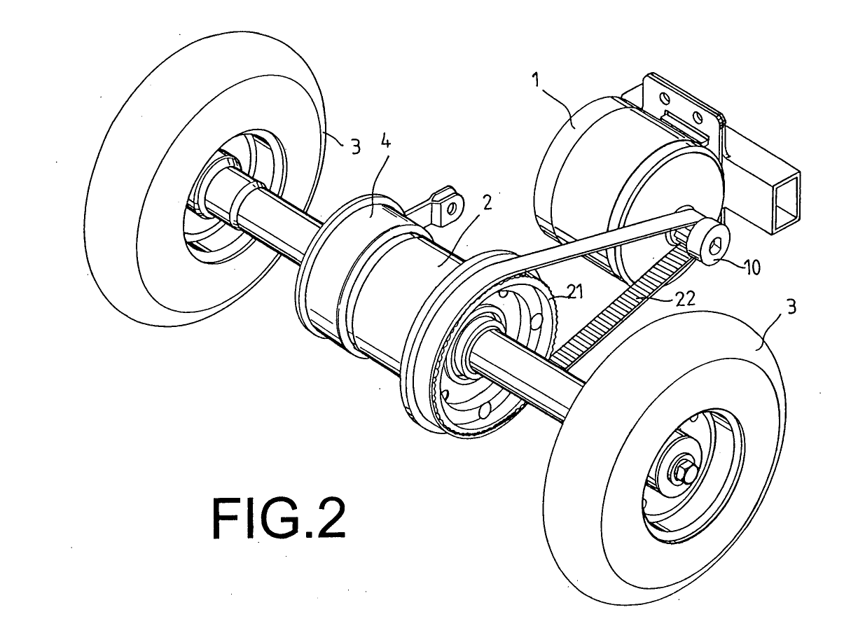

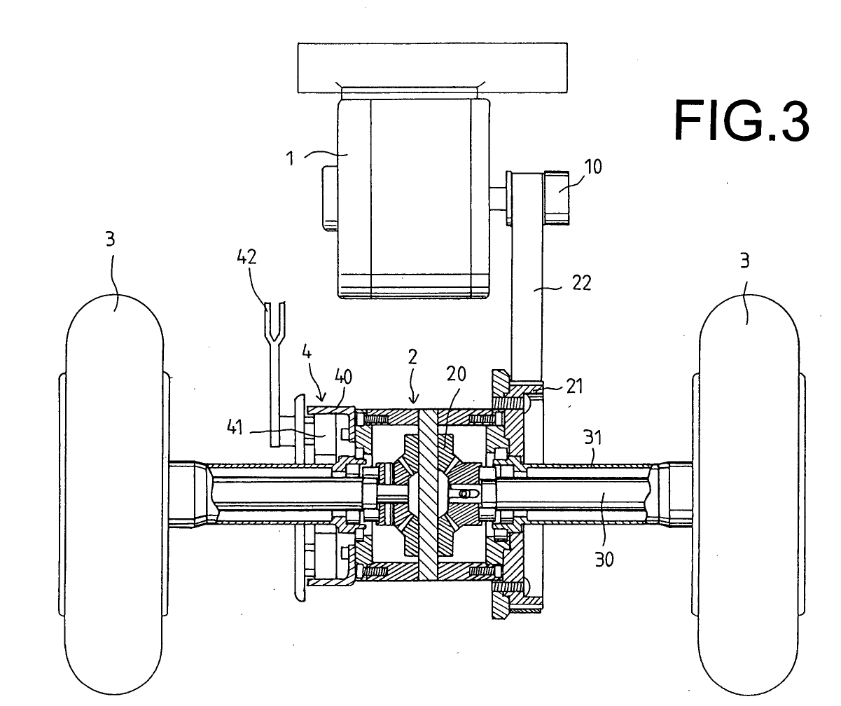

A first preferred embodiment of a vehicle differential gear in the present invention, as shown in FIGS. 1, 2 and 3, includes a power unit 1, a differential gear 2, two wheels 3 and a drum brake 4 combined together.

The power unit 1 composed of a motor or an engine is provided with a transmission wheel 10 extending outward from one side.

The differential gear 2 to be connected with the power unit 1 has a bevel gear unit 20 provided in the interior and a gear-shaped driven wheel 21 threadably assembled on one outer side of the differential gear 2. The driven wheel 21 and the transmission wheel 10 of the power unit 1 are connected with each other by a belt 2, so that the transmission wheel 10 of the power unit 1 can drive the differential gear to rotate.

The two wheels 3 to be respectively connected with the opposite sides of the differential gear 2 are respectively provided with a transmission shaft 30 meshed with the bevel gear unit 20 of the differential gear 2 so that the bevel gear unit 20 can actuate the two transmission shafts 30 to drive the two wheels 3 to rotate. Further, the transmission shaft 30 of each wheel 3 is covered with a shaft sleeve 31 for protection.

The drum brake 4 connected with the differential gear 2 is composed of a brake drum 40, a set brake horseshoes 41 and a control member 42. The brake drum 40 is threadably assembled on one side of the differential gear 2, able to rotate together with the differential gear 2. The brake horseshoe 41 and the driving member 42 are assembled on the shaft sleeve 31 of the wheel 3, with the brake horseshoe 41 received in the brake drum 40. Thus, when the brake horseshoes 41 are driven to expand outward by the control member 42, it will push against the inner wall of the brake drum 40 and force the brake drum 40 to stop rotating, and synchronously the differential gear 2 and the transmission wheel 10 of the power unit 1 will be actuated to stop rotating as well.

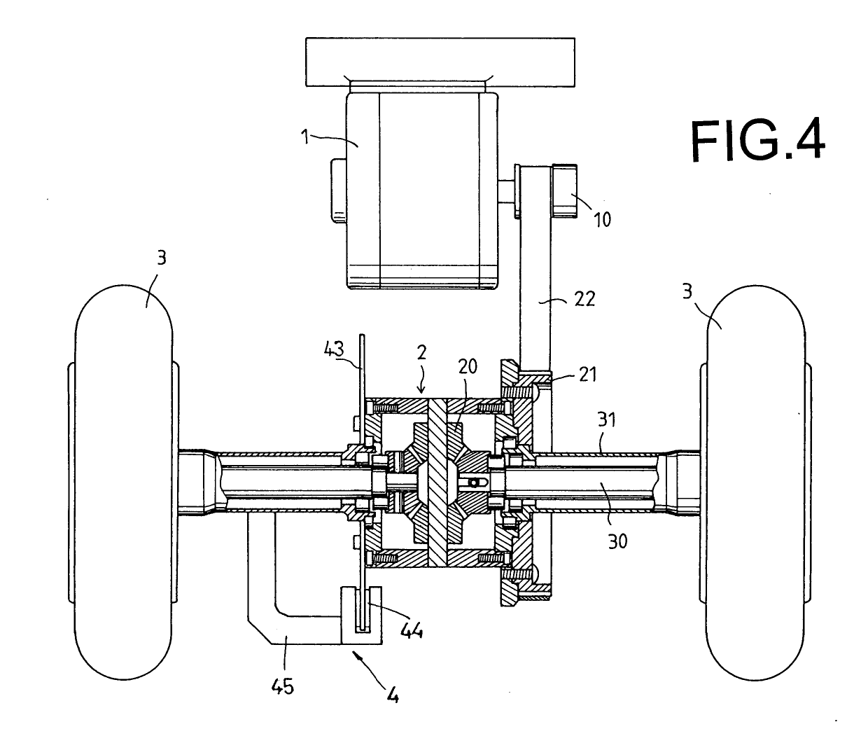

A second preferred embodiment of a vehicle differential gear in the present invention, as shown in FIG. 4, is provided with a saucer brake 4 instead of the drum brake 4 in the first preferred embodiment. The saucer brake 4 is composed of a brake saucer 43, a brake-clamping member 44 and a control member 45. The brake saucer 43 is fixed on one side of the differential gear 2 to rotate together with the differential gear 2. The brake-clamping member 44 and the control member 45 are assembled on the shaft sleeve 31 of the wheel 3, and the brake-clamping member 44 is aligned to and able to tightly clamp the brake saucer 43. Thus, when the control member 45 is operated to make the brake clamping member 44 clamp the brake saucer 43 tightly, the differential gear 2 and the transmission wheel 10 of the power unit 1 will simultaneously be actuated to stop rotating.

In assembling, as shown in FIGS. 1, 2 and 3 (or 4), firstly, choose a proper driven wheel 21 in its specification according to preset running speeds of a car and threadably assembled it on one outer side of the differential gear 2 and then connect it with the transmission wheel 10 of the power unit 1 by means of a belt 22. Next, the brake drum 40 (or the brake saucer 43) of the brake 4 is threadably fixed on the other side of the differential gear 2 and the two wheels 3 respectively have the transmission shaft 30 connected with the bevel gear unit 20 of the differential gear 2 to be driven to rotate. Then, the brake horseshoe 41 and the control member 42 (or the brake clamping member 44 together with the control member 45) of the brake 4 are assembled on the shaft sleeve 31 of the wheel 3 and aligned to the brake drum 40 (or the brake saucer 43).

To stop a car or reduce its running speeds, the control member 42 (45) of the brake 4 is operated to make the brake horseshoe 41 expand outward and push against the inner wall of the brake drum 40 (or make the brake clamping member 44 move inward to clamp the brake saucer 43) to stop the differential gear 2 and simultaneously force the transmission wheel 10 of the power unit 1 to stop rotating.

As can be understood from the above description, this invention has the following advantages.

1. A proper driven wheel can be chosen in its specification according to preset running speeds of a car and then it is threadably assembled on one outer side of the differential gear, needless to make various molds for producing various components to match with different running speeds of a car and thus saving producing cost.

2. The driven wheel of the differential gear is threadably assembled on one outer side of the differential gear so it can be separately connected with the power unit by a belt, improving the defect of the conventional differential gear that the differential gear and the motor are combined together and wrapped up by a sealing shell, reducing assembling cost and having practicability.

3. The brake assembled on the other outer side of the differential gear can be operated to directly control the differential gear to stop, able to brake a car smoothly and effectively.

While the preferred embodiments of the invention have been described above, it will be recognized and understood that various modifications may be made therein and the appended claims are intended to cover all such modifications that may fall within the spirit and scope of the invention.

1. A vehicle differential gear comprising:
a power unit provided with a transmission wheel extending outward from one side;
a differential gear connected with said power unit, said differential gear provided with a bevel gear unit in the interior, said differential gear having one outer side assembled thereon with a driven wheel, said driven wheel connected with said transmission wheel of said power unit by a belt to drive said differential gear to rotate;
two wheels respectively having a transmission shaft connected to the opposite sides of said differential gear, said transmission shaft connected with said bevel gear unit of said differential gear, said bevel gear unit rotating said transmission shafts and consequently said wheels as well; and,
said driven wheel chosen to match with preset running speeds of a car, said driven wheel threadably assembled on one outer side of said differential gear, needless to make various molds for producing various components to suit different speeds of a car, said vehicle differential gear convenient to be assembled and having practicability.

2. A vehicle differential gear comprising:
a power unit provided with a transmission wheel extending outward from one side;
a differential gear connected with said power unit, said differential gear provided with a bevel gear unit in the interior, said differential gear having one outer side assembled thereon with a driven wheel, said driven wheel connected with said transmission wheel of said power unit by a belt to rotate said differential gear to;
two wheels respectively having a transmission shaft connected with the opposite sides of said differential gear, said transmission shaft connected with said bevel gear unit of said differential gear, said bevel gear unit rotating said transmission shaft and consequently said wheel as well, said transmission shaft covered with a shaft sleeve;
a brake assembled with said differential gear, said brake composed of a brake saucer, a set of brake clamping members and a control member, said brake saucer fixed on one side of said differential gear to rotate together with said differential gear, said clamping members and said control member assembled on said shaft sleeve of said wheel, said brake clamping members aligned to and able to tightly clamp said brake saucer; and,
said driven wheel chosen for use according to preset running speeds of a car, said driven wheel assembled on one outer side of said differential gear, thus able to save cost in making various molds for producing various components to match with different running speeds of a car, said control member operated to control said brake clamping members to clamp said brake saucer, said differential gear actuated to stop rotating together with said brake saucer, said transmission wheel of said power unit actuated to stop rotating at the same time.

3. The vehicle differential gear as claimed in claim 2, wherein said brake is composed of a brake drum, a unit of brake horseshoes and a control member, said brake drum threadably assembled on one side of said differential gear to rotate together with said differential gear, said brake horseshoes and said control member assembled on said shaft sleeve of said wheel, said brake horseshoes received in said brake drum, said control member forcing said brake horseshoes to expand outward and push to stop said brake drum, said differential gear stopped rotating together with said brake drum, said transmission wheel of said power unit stopped rotating at the same time.
